(19) United States
(12) Patent Application Publication
(10) Pub. No.: US 2004/0248050 A1
(43) Pub. Date: Dec. 9, 2004

(54) Solutions for a photographic reversal bath and processing method for a photographic color reversal film

(76) Inventors: Didier J Martin, Givry (FR); Olivier J Poncelet, Cedex (FR)

Correspondence Address: PATENT LEGAL STAFF, EASTMAN KODAK COMPANY, 343 STATE STREET, ROCHESTER, NY, 14650-2201, US

(21) Appl. No.: 10/493,350

(22) PCT Filed: Oct. 12, 2002
(86) PCT No.: PCT/EP02/11439

(30) Foreign Application Priority Data
Oct. 29, 2001 (FR) 01/13927

(51) Int. Cl. G03C 5/50

(52) U.S. Cl. 430/407

(57) ABSTRACT

The present invention relates to a concentrated solution for photographic reversal baths, and to a ready-to-use reversal solution, for limiting the growth of microorganisms and biofilm formation.

These solutions comprise a chelating agent comprising an alkali metal salt of a phosphonic or phosphinic acid, and a biological growth control agent, said biological growth control agent comprising a mixture of at least one quaternary ammonium compound with short alkyl chain and at least one polymeric quaternary ammonium compound that is highly soluble in water, the total concentration of quaternary ammonium compounds being less than or equal to 0.5 g/l.

### FIELD OF THE INVENTION

The present invention relates to a concentrated solution to prepare a ready-to-use photographic reversal bath, to a ready-to-use reversal solution for photographic reversal bath and to a processing method for an exposed photographic color reversal film using said reversal bath solution.

### BACKGROUND OF THE INVENTION

In the conventional processing of color reversal films, the reversal step between the black-and-white development step and the color development step is conducted either chemically (using a chemical agent) or by fogging. In the reversal step, silver halides not initially exposed are rendered developable. Such a processing method of color reversal films is well known and described in detail in “Chimie et Physique Photographiques” Volume 2, P. Glafkidès, 5th edition, Chapter XL, pages 947-967.

One example of such a color reversal processing is the Ektachrome E-6® process described in detail on page 954 of the above mentioned handbook. During the Ektachrome E-6® photographic process, the photographic film is successively circulated through a black-and-white development bath, a first washing bath, a chemical reversal bath, a color development bath, a conditioning bath, a bleaching bath, a fixing bath, one or more washing baths, and a rinsing bath. Then, a drying step is carried out.

Generally, it is desired that photographic films be developed automatically and as fast as possible. During the circulation of the photographic film from bath to bath, significant amounts of chemical compounds are carried over from one bath to another either by means of the photographic film, or by the conveyor belts of the photographic processor. These chemical compounds build-up in the processing baths and thus reduce their efficiency. Bath contamination by carry-over of chemical compounds gets more significant as the processing of photographic materials gets faster. In order to prevent these problems of contamination, washing baths are provided between each processing bath. However, this method results in significant consumption of water. New standards especially require the reduction of water consumption for photographic processing. The problem is that by reducing the volume of water permitted, bacterial pollution and growth of other microorganisms in the aqueous solutions are promoted. The growth of microorganisms, such as yeast and fungi, if it is not controlled, results in formation and precipitation of sludge resulting in the installation clogging up, the deterioration of the processing bath, and thus poor quality of the photographic image. In addition, the presence of microorganisms results in a biofilm to form on the walls of the processing tanks and on the film rollers and sprockets, which requires the machines to be stopped for cleaning.

Use of control agents to prevent or limit biological growth is a current practice. Such biological growth control agents can be quaternary ammonium compounds. For example, Hyamine® 1622 (benzyldimethyl [2-{2-[4-(1,1,3,3-tetramethylbutyl)phenoxy]ethoxy}ethyl] ammonium) chloride, commercially available from Lonza Inc., which is known for its bactericide and anti-odor action has been used in reversal baths. However, this compound having a long hydrophobic chain exhibits a low solubility in water and does not enable efficient control of the biological growth. In addition, Hyamine® 1622 forms complexes with some materials present in the reversal bath and precipitates. Other solutions described for example in the U.S. Pat. No. 5,736,302 consist of using a specific quaternary ammonium compound that is more soluble in water, as sole biological growth control agent. However, such compounds, if they are efficient against bacterial growth, do not prevent the formation of other microorganisms, such as fingi and yeast, responsible for biofilm formation. In addition, usefull biological growth control agents must be compatible with the other ingredients of the reversal bath solution, especially when in its concentrated form.

The present invention provides a reversal bath solution comprising an efficient biological growth control agent to prevent both bacterial growth and biofilm formation, while being compatible with the other ingredients of the solution, for example allowing the properties of stannous ions used as reducing agent of silver ions undeveloped after the first black-and-white development to be maintained.

The present invention provides also a concentrated solution for reversal bath that enables the reduction of the conditioning volumes and remains stable despite the high concentrations of its ingredients.

### SUMMARY OF THE INVENTION

The present invention relates to a concentrated solution for a photographic reversal bath, comprising:

a) stannous ions, preferably in a concentration of 20 g/l or more,

b) a chelating agent comprising an alkali metal salt of phosphonic or phosphinic acid, and

c) a biological growth control agent,

said biological growth control agent comprising a mixture of at least one quaternary ammonium compound of formula (I) and at least one polymeric quaternary ammonium compound of formula (II),

R₁(R₂)N⁺(R₃)R₄X⁻ (I)

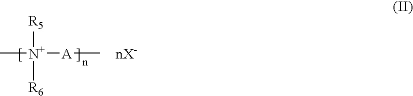

wherein R₁, R₂, R₃ and R₄ are independently nonpolymeric aliphatic, heterocyclic or carbocyclic radicals,

X⁻ is a halide,

R₅ and R₆, which can be the same or different, each represent an alkyl radical of 1 to 4 carbon atoms, optionally substituted with an hydroxyl group,

A represents a divalent hydrocarbon radical containing 1 to 10 carbon atoms, said divalent hydrocarbon radical being substituted with at least one hydroxyl radical,

n represents an integer of from 2 to 100, the total concentration of quaternary ammonium compounds (I) and (II) being 0.5 g/l or less.

Preferably, the concentration of quaternary ammonium (I) and (II) is 0.1 g/l or less.

The present invention also concerns a ready-to-use reversal solution for photographic reversal bath, obtainable by dilution of said concentrated solution, and comprising

a) stannous ions, preferably in a concentration of 0.6 g/l or more,

b) a chelating agent comprising an alkali metal salt of phosphonic or phosphinic acid, and

c) a biological growth control agent,

said biological growth control agent comprising a mixture of at least one quaternary ammonium compound of formula (I) and at least one polymeric quaternary ammonium compound of formula (II),

R₁(R₂)N⁺(R₃)R₄X⁻ (I)

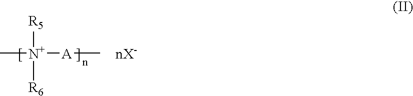

wherein R₁, R₂, R₃, R₄, R₅ and R₆, X⁻, A, and n are as defined above, the concentration of quaternary ammonium (I) and (II) being 10 ppm or less.

Preferably, the total concentration of quaternary ammonium compounds (I) and (II) in the ready-to-use solution is 5 ppm or less.

The present invention also relates to an exposed color reversal photographic film processing method comprising the circulation of said exposed film in a ready-to-use reversal bath solution as defined above, and the color development of said film.

### DETAILED DESCRIPTION OF THE INVENTION

Many color reversal photographic films can be processed by the processing method according to the invention, such as Ektachrome® films commercially available from Eastman Kodak Company. A detailed description of these films can be found for example in Research Disclosure, Item 38957, pages 592-639 (September 1996). Research Disclosure is published by Kenneth Mason Publications, Ltd., Dudley House, 12 North Street, Emsworth, Hampshire PO10 7DQ England.

The processing method according to the invention can use the same baths as the processing methods for color reversal films of the prior art, such as the E6® process developed by Eastman Kodak Company, except for the reversal bath, being replaced by the reversal solution according to the invention.

Said reversal solution according to the invention can be prepared directly from its ingredients to be ready to use or can be prepared as a concentrated solution, to be diluted in water before use.

As the concentrated solution for reversal bath and the ready-to-use reversal solution for reversal bath according to the invention comprise the same ingredients, with only the concentrations being different, the following description of said ingredients relates to both types of solutions. In the following description, the term “reversal solution” will generally refer to the concentrated reversal solution and the ready-to-use reversal solution without distinguishing the concentrations. As is known, the reversal solution comprises a nucleating agent such as stannous ions usually present as stannous salts, such as stannous chloride, stannous bromide, stannous fluoride and stannous acetate. Preferably stannous chloride is used. Stannous ions are present in the reversal solution in sufficient amount to render residual silver halides developable after the black-and-white development of the latent image.

The stannous ion concentration is 20 g/l or more in the concentrated reversal solution, and 0.6 g/l or more in the ready-to-use reversal solution. Preferably, the stannous ion concentration is less than 40 g/l in the concentrated solution, and less than 1.5 g/l in the ready-to-use reversal solution.

According to the invention, the reversal solution comprises a biological growth control agent, comprising a mixture of at least one quaternary ammonium of formula (I) and at least one polymeric quaternary ammonium of formula (II),

R₁(R₂)N⁺(R₃)R₄X⁻ (I)

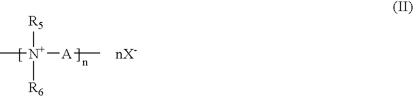

Quaternary ammonium compounds (I) useful in the present invention have a short alkyl chain and molecular weights preferably less than 440 in order to exhibit a higher water solubility than other biological growth control agents having a higher molecular weight. Thus, Hyamine® 1622, with a molecular weight of about 448, results in the formation of precipitates and cannot be used in reversal baths.

R₁, R₂, R₃ and R₄ are independently nonpolymeric aliphatic, heterocyclic or carbocyclic radicals. The term “aliphatic” means a monovalent radical with 1 to 30 carbon atoms. Aliphatic groups can be substituted for example with halogen radicals, by methods known to those skilled in the art. The term “heterocyclic” means a monovalent organic radical having at least one heterocyclic group containing one or more oxygen, nitrogen or sulfur atoms. The heterocyclic group can be aromatic or not and can comprise up to 15 atoms in the ring. The ring can be substituted with one or more organic groups, using methods known to those skilled in the art. The term “carbocyclic” means a monovalent organic radical having only carbon atoms in the ring, and comprises cycloalkyl, cycloalkenyl and aryl groups. Such rings usually comprise up to 14 carbon atoms on the ring that can be substituted with one or more organic groups, using methods known to those skilled in the art.

Quaternary ammonium compounds (I) especially useful in the present invention have only one or two radicals R₁, R₂, R₃ and R₄ that include one to three carbon atoms, the other groups being much larger, having for example at least eight carbon atoms.

The anion X⁻ is a halide selected not to form precipitates in the reversal bath solution. Chloride is especially preferred.

Quaternary ammonium compounds (I) useful in the present invention can be selected from among the non-limiting group comprising nonyltrimethylammonium chloride, dodecyltrimethylammonium chloride, hexadecyltrimethylammonium chloride, benzyltriethylammonium chloride, benzyldimethylphenylammonium chloride, tetrahexylammonium chloride, a benzalkonium chloride (i.e. a mixture of alkyldimethylbenzyl ammonium chlorides), a mixture of alkyltrimethylammonium chlorides, and mixtures thereof. The preferred quaternary ammonium compound (I) for the invention is a mixture of dodecyl-(40%), tetradecyl-(50%) and hexadecyl-(10%) dimethylbenzyl-ammonium chlorides, having a molecular weight of 423.

Most of these quaternary ammonium compounds (I) are commercially available from many distributors known to those skilled in the art.

Polymeric quaternary ammonium compounds (II) useful in the present invention include groups R₅ and R₆, that can be the same or different, each representing an alkyl radical of 1 to 4 carbon atoms, optionally substituted with a hydroxyl group, and a group A representing a divalent hydrocarbon radical containing 1 to 10 carbon atoms, said divalent hydrocarbon radical being substituted with at least one hydroxyl radical, so as to be highly soluble in water. n is an integer of 2 to 100. Preferably, A is hydroxypropylene radical:

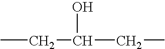

Such polymeric quaternary ammonium compounds (II) are obtained by reacting a secondary amine with epichlorohydrin, as described in the U.S. Pat. No. 3,738,945.

The polymeric quaternary ammonium (II) especially preferred for the invention is poly(2-hydroxyethylenedimethyliminio-2-hydroxypropylene-dimethyliminiomethylene) dichloride, obtained by polymerization reaction between dimethylamine and epichlorohydrin. The polymer obtained has a molecular weight of from 5000 to 10 000. This polymer is commercially available for example under the trade name Busan® 1055.

The biological growth control agent used in the present invention has the form of an aqueous solution obtained by mixing in water at least one quaternary ammonium compound (I) with at least one quaternary ammonium compound (II), in a weight ratio (I):(II) of from 1:5 to 5:1, and preferably from 1:1 to 2:1, the amount of the quaternary ammonium compounds (I) and (II) accounting for from 10% to 50% by weight, based on the total weight of the aqueous solution, and preferably from 20% to 30% by weight, based on the total weight of the aqueous solution. Said aqueous solution can also include an alcohol, such as isopropanol, in an amount less than 5% by weight, based on the total weight of the solution.

The biological growth control agent is added to the concentrated solution for the reversal bath so as to achieve a total concentration of quaternary ammonium compounds (I) and (II) less than or equal to 0.5 g/l, and preferably less than or equal to 0.1 g/l. In the ready-to-use reversal solution, the amount of biological growth control agent is such that the concentration of quaternary ammonium (I) and (II) is less than or equal to 10 ppm, and preferably less than or equal to 5 ppm.

The reversal solution according to the invention also contains one or more chelating agents including an alkali metal salt of a phosphonic or phosphinic acid. Such chelating agents are usually represented by the formulas (III) or (IV),

R₇N(CH₂PO_{z}M₂)₂ (III)

R₈R₉C(PO_{z}M₂)₂ (IV)

wherein z is 2 or 3,

R₇ is selected from the group consisting of hydrogen, an alkyl group of 1 to 12 carbon atoms, an alkylaminoalkyl group wherein each alkyl group has 1 to 12 carbon atoms, an alkoxyalkyl group of 2 to 12 carbon atoms, a cycloalkyl group of 5 to 10 carbon atoms in the ring, a 5- to 10-membered heterocyclic group having one or more nitrogen, oxygen or sulfur atoms in the heterocyclic ring, or —CHR₁₀PO_{z}M₂.

R₈ is selected from the group consisting of hydrogen, an alkyl group of 1 to 12 carbon atoms, an aryl group of 6 to 10 carbon atoms in the aromatic ring, a cycloalkyl group of 5 to 10 carbon atoms in the ring, a 5- to 10-membered heterocyclic group having one or more nitrogen, oxygen or sulfur atoms in the heterocyclic ring, —PO_{z}M₂ or —CHR₁₀PO_{z}M₂,

R₉ and R₁₀ are independently selected from the group consisting of hydrogen, a hydroxy group, an alkyl group of 1 to 12 carbon atoms, or PO_{z}M₂, and M is hydrogen.

The phosphonic acids whose salts can be used in the present invention are 1-hydroxyethylidene-1,1-diphosphonique acid and aminotris(methylenephosphonic) acid. Preferably, aminotris(methylenephosphonic) acid will be used as sold for example under the trade name Dequest® 2000. The metal salt can be obtained by the addition, in the corresponding phosphonic acid, of a base with a corresponding metal part, such as sodium hydroxide or other bases known to those skilled in the art.

The concentration in the concentrated solution for the reversal bath of phosphonic or phosphinic acid is in general more than or equal to 60 g/l. In an especially advantageous way, the concentration of phosphonic or phosphinic acid used to produce the concentrated solution for the reversal bath according to the invention is more than or equal to 125 g/l. With this concentration value, the biological growth control agent used in the reversal solutions according to the invention have improved efficiency in preventing the formation and deposit of yeast and fungi, and their precipitation on the surface of the reversal bath tank.

Reversal solutions according to the invention can include other known usual ingredients, such as a stannous ion stabilizer and a buffering agent. Stannous ion stabilizers useful in the present invention are for example p-aminophenol and phenylenediamine. Preferably, p-aminophenol is used. The concentration of stannous ion stabilizer in the concentrated solution for reversal bath is more than 0.005 g/l and preferably in the range of from 0.01 g/l to 2 g/l. In the ready-to-use reversal solution, the concentration of stannous ion stabilizer is more than or equal to 0.1 mg/l and preferably in the range of from 0.2 mg/l to 0.8 mg/l.

Buffering agents useful in the present invention can be the combination of propionic acid with a propionate or a combination of acetic acid with an acetate. Preferably, reversal solutions according to the invention do not contain propionic acid that generates bad odors. The acetic acid concentration in the concentrated reversal solution is preferably more than or equal to 100 g/l and preferably more than 3 g/l in the ready-to-use reversal solution. The buffering agent is formed after the addition of a base, such as sodium hydroxide, such that the pH of the concentrated solution for reversal bath is in the range of from 4.5 to 5.5, preferably from 5 to 5.5 and ideally from 5.2 to 5.4.

When the ready-to-use reversal solution is obtained by diluting the concentrated solution for reversal bath according to the invention, said concentrated solution can be diluted up to 30 times in water. A rate of dilution between 15 and 20 is especially preferred.

For the processing of a color reversal photographic film according to the method of the present invention, the ready-to-use reversal solution is poured into the reversal bath tank in which the exposed film is to circulate. Except for the composition of the reversal bath being the object of the present invention, the processing method for a color reversal film as well as the composition of the other baths of said method are known to those skilled in the art and require no further description.

Reversal bath solutions according to the present invention have good stability both during storage and in use in the reversal bath, especially in relation to the stannous or tin II ion concentration. After six months, no precipitate or crystallization is observed, whether for the concentrated solution or the ready-to-use diluted solution. Furthermore, they are especially efficient in preventing the formation and deposit of fungi and yeast at the origin of biofilm formation. Thus, reversal bath replenishment rate can be reduced. In addition, reversal solutions according to the invention enable the reduction, by at least a factor of two, of the amount of active biological growth control agents compared to solutions currently used, without observing any impact on the sensitivity and stability of the image of the developed film.

Processing method according to the present invention can be combined with a reversal bath processing method by nanofiltration as described in the Patent Application FR 01/06331 filed May 15, 2001. In this method, effluents from the reversal bath are collected and sent into a nanofiltration unit to provide a permeate, which is then reinjected into the first washing bath. Because of their molecular weight, the quaternary ammonium compounds (I) will go through the nanofiltration membrane and will be able to play a role of biological growth control agent in the first washing bath.

The processing method according to the invention can also be combined with the processing method described in the U.S. patent application Ser. No. 09/788,748, filed Feb. 20, 2001 under French priority of Mar. 7, 2000, a method by which the water level of the first washing bath is maintained by a counter-current coming from the reversal bath, and the water from said washing bath goes through a nanofiltration unit. By means of the counter-current, the biological growth control agent used in the reversal bath solution according to the invention is injected into the first washing bath where it will also be able to play its role enabling there again prevention of the formation and deposit of fungi and yeast at the origin of biofilm formation in said first washing bath.

The invention is further described in the following examples.

### EXAMPLES 1-3

### Reversal Solutions with Various Biological Growth Control Agents

A solution of biological growth control agent used according to the present invention was prepared, called “QA (I)+PQA (II) mixture” corresponding to the mixture of the quaternary ammonium compound (I) and the polymeric quaternary ammonium compound (II).

QA (I) + PQA (II) mixture (percent by weight):

| | |
|---|---|
| QA (I): Dodecyl-(40%), tetradecyl-(50%) and hexadecyl-(10%) | 12% |
| dimethylbenzyl-ammonium chlorides | |
| PQA (II): Poly(2-hydroxyethylenedimethyliminio-2- | 9% |
| hydroxypropylene-dimethyliminiomethylene) dichloride | |
| Water | 77% |
| Isopropanol | 2% |

One liter of concentrated solution for reversal bath according to the invention was prepared by mixing the following compounds:

| | |
|---|---|
| Deionized water | 550 g |
| Acetic acid (90%) | 116.66 g |
| Dequest ® 2000 (50%) | 125 g |
| Sodium hydroxide (50%) | 186.76 |
| Stannous chloride, dihydrate | 39.26 |
| p-aminophenol | 0.01 g |
| QA (I) + PQA (II) mixture | 0.4 g |

To obtain one liter of ready-to-use reversal solution according to the invention, 50 ml of the concentrated solution prepared as above were diluted in water.

As indicated in Table I below, 0.4 g of the QA (I)+PQA (II) mixture were used as prepared above in the concentrated solution or 20 ppm in the ready-to-use solution to obtain 4.6 ppm of quaternary ammonium in the ready-to-use reversal solution.

Comparative tests were performed by replacing the QA (I)+PQA (II) mixture by two other biological growth control agents (BGCA), i.e. Empigeng BAC50 which is an alkyldimethyibenzylammonium chloride, and a N-alkyltrimethylammonium bromide.

The various BCGAs tested as well as their concentration in the ready-to-use reversal solution, are summarized in Table I below.

TABLE I

| | Concentration |
|---|---|
| | of quaternary |
| | ammonium in the |
| | ready-to-use reversal |
| BGCA | solution (ppm) |
| Example 1: Empigen ® BAC 50 (Comp.) | 10 |
| Example 2: N-alkyltrimethylammonium | 10 |
| bromide (Comp.) | |
| Example 3: QA (1) + PQA (II) mixture | 4.6 |
| (Invention) | |

A Noritsu QSF-R410L-3 E6 minilab commercially available from Noritsu Company was used, with a “washless” configuration, by which water consumption is reduced by removing the continuous water supply of the first washing bath and the final washing baths. In order to season the baths, ten exposed films a day were developed in this minilab (KODAK ELITECHROME 100® and KODAK EKTACHROME 100 Plus Professional®, five rolls of each film a day for 3 days) using the Ektachrome E-6® process. The minilab used the following sequence.

| E-6 baths | Time | Temperature ° C. | Service rate |
|---|---|---|---|
| First black-and-white | 6 min | 38 | 2150 ml/m² |
| development | | | |
| First washing bath | 2 min 30 s | 30-35 | 0 ml/m² |
| Reversal bath with | 2 min 30 s | 38 | 1075 ml/m² |
| counter-current in | | | |
| first washing bath | | | |
| Color development | 6 min | 38 | 2150 ml/m² |
| Conditioner | 2 min 30 s | 38 | 1075 ml/m² |
| Bleaching | 6 min | 40 | 230 ml/m² |
| Fixing | 2 min 30 s | 38 | 1075 ml/m² |
| Final wash | 2 min 30 s | 30-35 | counter-current |
| Final wash | 2 min 30 s | 30-35 | counter-current |
| Rinsing | 2 min 30 s | 30-34 | 2150 ml/m² |

As the experiment was performed in “washless” conditions, the water from the first washing bath was not replenished by the addition of external fresh water. At the beginning, water used in the first washing bath was replaced by nanofiltered fresh water. The water level of the first washing bath was maintained by a counter-current from the reversal bath. The sequence ended conventionally with a drying operation (temperature >67° C.).

The wastewater of the various washing baths was collected and routed to a nanofiltration unit equipped with NF45 FILMTEC® membrane having a specific surface treatment surface area of 2.21 m² sold by Dow Europe Separation Systems®, and operating at a pressure of 10⁶ Pa. The water recovered in the permeate was reinjected into the various washing baths.

For each reversal solution, the amount of bacteria and yeast formed in the reversal bath over time was measured, and biofilm formation and fungi development were observed. Measurements of bacteria and yeast were made by the epifluorescence DAPP method as described in the publication, Comparison of methods for determination of microbial biomass in wastewater, Vollertsen, J.; Jahn, A. Lund Nielsen, J. Hvitved-Jacobsen, T.; Halkjaer Nielsen, P. Sohngaardsholmsvej 57, Environmental Engineering Laboratory, Aalborg University, 9000, Aalborg, Den. Water Res. (2001), 35 (7), 1649-1658.

The results of these measurements are given in Table II.

TABLE II

| | | | | Ob- | |
|---|---|---|---|---|---|
| | | | | serva- | |
| BGCA | Time | Bact/ml | Yeast/ml | tions | Comments |
| Example 1 | 1 day | 4.0^{E} + 05 | 1.0^{E} + 00 | | Clear, no |
| (Comp.) | | | | | precipitate |
| | 7 days | 6.4^{E} + 06 | 2.0^{E} + 04 | Bd | Yeast, fungi, |
| | | | | | significant |
| | | | | | precipitate |
| Example 2 | 1 day | 1.5^{E} + 05 | 1.5^{E} + 04 | Bd | Clear, no |
| (Comp.) | | | | | precipitate |
| | 7 days | 2.0^{E} + 04 | 1.04^{E} + 04 | Bd | Biofilm |
| | | | | | precipitate |
| Example 3 | 1 day | 2.5^{E} + 05 | 4.0^{E} + 03 | | Clear, no |
| (Invention) | | | | | precipitate |
| | 7 days | 9.0^{E} + 03 | 3.0^{E} + 03 | | Slight deposit |
| | | | | | of yeast and |
| | | | | | fungi |

Bact./ml = bacteria/ml
Bd = Biofilm debris

The reversal solution (Ex. 3) comprising the biological growth control agent QA (I)+PQA (II) according to the invention enabled the reduction of the bacterial growth and especially enabled the limitation of the growth of particular species such as yeast, spores and fungi, responsible for the formation of biofilms and precipitates.

The biological growth control agent QA (I)+PQA (II) was more efficient than other biological growth control agents, with a lower concentration by weight (4.6 ppm instead of 10 ppm).

### EXAMPLES 4-6

### 1) Reversal Bath Analysis

The experiment of Examples 1-3 was repeated, but using a concentration of the chelating agent Dequest 2000® (50%) of 250 g/l in the concentrated reversal bath solution.

Different tests were performed using ready-to-use reversal solutions each including a biological growth control agent in the concentrations given in the Table III.

TABLE III

| | Concentration of quaternary |
|---|---|
| | ammonium in the ready-to-use |
| BGCA | reversal solution (ppm) |
| Example 4: Hyamine ® 1622 (Comp.) | 5 |
| Example 5: | 10 |
| N-alkyltrimethylammonium bromide | |
| (Comp.) | |
| Example 6: QA (1) + PQA (II) mixture | 4.6 |
| (Invention) | |

For each reversal solution, the amount of bacteria and yeast formed in the reversal bath over time was measured, and biofilm formation and fungi growth was observed.

The results of these measurements are given in Table IV.

TABLE IV

| | | | | Obser- | |
|---|---|---|---|---|---|
| BGCA | Time | Bact/ml | Yeast/ml | vations | Comments |
| Example 4 | 1 day | 2.0^{E} + 02 | 1.0^{E} + 01 | Bd | Clear, no |
| (Comp.) | | | | | precipitate |
| | 3 days | 2.0^{E} + 02 | 1.0^{E} + 02 | Bd | Fine precipitate |
| | 7 days | 1.0^{E} + 07 | 2.0^{E} + 04 | Bd | Precipitate, |
| | | | | | biofilm |
| Example 5 | 1 day | 5.6^{E} + 04 | 1.0^{E} + 01 | Bd | Clear |
| (Comp.) | | | | | |
| | 3 days | 2.0^{E} + 02 | 1.0^{E} + 01 | | Clear |
| | 14 days | 7.8^{E} + 03 | 1.0^{E} + 01 | | Deposits of |
| | | | | | fungi on |
| | | | | | conveyor |
| | | | | | system |
| Example 6 | 1 day | 1.7^{E} + 04 | 0.0^{E} + 00 | | Clear, no |
| (Invention) | | | | | biofilm or |
| | | | | | deposit of |
| | | | | | fungi |
| | 3 days | 2.6^{E} + 04 | 0.0^{E} + 00 | | Clear, no |
| | | | | | biofilm or |
| | | | | | deposit of |
| | | | | | fungi |
| | 14 days | 5.4^{E} + 03 | 0.0^{E} + 00 | | Clear, no |
| | | | | | biofilm or |
| | | | | | deposit of |
| | | | | | fungi |

Bact./ml = bacteria/ml
Bd = Biofilm debris

These results demonstrate that a concentration of chelating agent Dequest® 2000 of 250 g/l in the concentrated reversal solution associated with the use of the mixture QA (I)+PQA (II) (Ex. 6) according to the present invention improved the advantages already obtained in Example 3. In fact, at this concentration of chelating agent in the concentrated reversal solution, no development of yeast and spores, responsible for biofilm and precipitate formation was observed in the reversal bath. Reversal solutions according to the invention also prevented the deposit of fungi on the film conveyor system in the reversal bath tank. This reduced tank cleaning frequency.

### 2) Analysis of the First Washing Bath

According to the processing method described in Examples 1-3, a certain amount of reversal bath solution goes into the first washing bath due to the counter-current. Consequently, the biological growth control agent also goes into the first washing bath.

For each biological growth control agent used in the reversal solution, the amount of bacteria and yeast formed in the first washing bath over time was measured, and biofilm formation and fungi growth was observed.

The results are given in Table V.

TABLE V

| | | | | Ob- | |
|---|---|---|---|---|---|
| | | | | ser- | |
| | | | | va- | |
| BGCA | Time | Bact/ml | Yeast/ml | tions | Comments |
| Example 4 | 1 day | 1.0^{E} + 05 | 1.0^{E} + 03 | Bd | Clear, no |
| (Comp.) | | | | | precipitate |
| | 3 days | 2.0^{E} + 05 | 2.0^{E} + 02 | Bd | Fine precipitate |
| | 7 days | 1.0^{E} + 08 | 1.0^{E} + 04 | Bd | Precipitate, |
| | | | | | biofilm |
| Example 5 | 1 day | 1.7^{E} + 05 | 1.0^{E} + 01 | | Clear |
| (Comp.) | 3 days | 3.2^{E} + 03 | 4.6^{E} + 04 | | Pseudomycelium |
| | 14 days | 2.4^{E} + 06 | 3.6^{E} + 04 | | Biofilm |
| Example 6 | 1 day | 2.0^{E} + 06 | 0.0^{E} + 00 | | Clear, no biofilm |
| (Invention) | | | | | or deposit of |
| | | | | | fungi |
| | 3 days | 3.0^{E} + 07 | 0.0^{E} + 00 | | Clear, no biofilm |
| | | | | | or deposit of |
| | | | | | fungi |
| | 14 days | 1.0^{E} + 06 | 0.0^{E} + 00 | | No biofilm, or |
| | | | | | precipitate or |
| | | | | | deposit of fungi |

The same advantages were seen as those observed for the reversal bath, i.e. limitation of the proliferation of yeast and biofilm formation by using reversal solutions according to the present invention.

### EXAMPLE 7

Monitoring of the photographic quality of the processing using the invention method was carried out. The baths were first seasoned by treating ten exposed films a day (KODAK ELITECHROME 100® and KODAK EKTACHROME 100 Plus Professionals, five rolls of each film a day for 3 days) using the Ektachrome E-6® process.

The processing quality was monitored for 2 weeks using control strips, catalogued under the trade name “Kodak Control Strips, Process E-6 (emulsion 9041)” supplied by the Eastman Kodak Company. The control strip measurements were then compared with a reference, representing the optimum operating characteristics for the Ektachrome E-6 process. These control strips were used according to the manual “Process E-6 using Kodak chemicals”, Chapter 13, No Z-119 published by Eastman Kodak Company (October 1997).

With the reversal bath comprising the ready-to-use reversal solution according to the invention, a control strip that stayed within the required standards was obtained.

### EXAMPLES 8-11

Solutions of the various biological growth control agents tested above were passed through the nanofiltration membrane NF45 FILMTEC® to measure the retention rate of said biological growth control agents and to study their distribution between the retentate and the permeate during a nanofiltration treatment used in combination with the processing method according to the invention. The results are given in Table VI.

TABLE VI

| | Concentration in | |
|---|---|---|
| | quaternary ammonium | |
| | in the tested | Retention |
| BGCA | solution (ppm) | rate (%) |
| Example 8: Empigen ® BAC 50 | 20 | 64 |
| Example 9: | 10 | 45 |
| N-alkyltrimethylammonium bromide | | |
| Example 10: QA (1) + PQA (II) | 5 | 48 |
| mixture | | |
| Example 11: Hyamine ® 1622 | 5 | 100 |

Table VI demonstrates that the mixture QA (I)+PQA (II) (Ex. 10) used in the reversal solutions according to the present invention, because of its short alkyl chain, had a retention rate less than larger quaternary ammonium compounds such as Empigen® and Hyamine®. Hence, the biological growth control agent used in the reversal solution according to the invention can in part pass into the permeate and circulate in the nanofiltration unit and the washing baths, thus reducing biological growth in said nanofiltration unit and said washing baths.

What is claimed is:

1. A concentrated solution for photographic reversal baths, comprising:
a) stannous ions,
b) a chelating agent comprising an alkali metal salt of phosphonic or phosphinic acid, and
c) a biological growth control agent,
wherein said biological growth control agent comprises a mixture of at least one quaternary ammonium compound of formula (I) and at least one polymeric quaternary ammonium compound of formula (II),
R₁(R₂)N⁺(R₃)R₄X⁻ (I) 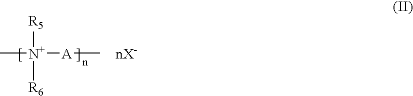
wherein R₁, R₂, R₃ and R₄ are independently nonpolymeric aliphatic, heterocyclic or carbocyclic radicals,
X⁻ is a halide,
R₅ and R₆, which can be the same or different, each represent an alkyl radical of 1 to 4 carbon atoms, optionally substituted with an hydroxyl group,
A represents a divalent hydrocarbon radical of 1 to 10 carbon atoms, said divalent hydrocarbon radical being substituted with at least one hydroxyl radical,
n is an integer of from 2 to 100,
and wherein the total concentration of quaternary ammonium compounds (I) and (II) is less than or equal to 0.5 g/l.

2. The solution of claim 1 wherein the concentration of quaternary ammonium (I) and (II) is less than or equal to 0.1 g/l.

3. The solution of claim 1 wherein the chelating agent comprising an alkali metal salt of an organic phosphonic or phosphinic acid is obtained from a concentration more than or equal to 125 g/l of the corresponding phosphonic or phosphinic acid and a corresponding metal base.

4. The solution of claim 1 wherein the concentration of stannous ions is more than or equal to 20 g/l.

5. A ready-to-use reversal solution for photographic reversal bath, comprising
a) stannous ions,
b) a chelating agent comprising an alkali metal salt of phosphonic or phosphinic acid, and
c) a biological growth control agent,
wherein said biological growth control agent comprises a mixture of at least one quaternary ammonium compound of formula (I) and at least one polymeric quaternary ammonium compound of formula (II),
R₁(R₂)N⁺(R₃)R₄X⁻ (I) 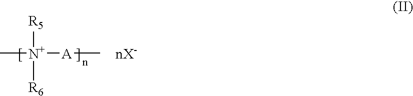
wherein R₁, R₂, R₃, R₄, R₅ and R₆, X⁻, A, are as defined above,
the concentration of quaternary ammonium (I) and (II) being less than or equal to 10 ppm.

6. The ready-to-use solution of claim 5 wherein the total concentration of quaternary ammonium compounds (I) and (II) is less than or equal to 5 ppm.

7. The ready-to-use solution of claim 5 wherein the concentration of stannous ions is more than or equal to 0.6 g/l.

8. The ready-to-use solution of claim 5 obtainable by the dilution in water of the concentrated solution according to any of claims 1 to 4.

9. The solution of claim 1 or 5 wherein X⁻ is a chloride.

10. The solution of claim 1 or 5 wherein the quaternary ammonium (I) is selected from the group consisting of nonyltrimethylammonium chloride, dodecyl-trimethylammonium chloride, hexadecyltrimethylammonium chloride, benzyltriethylammonium chloride, benzyldimethylphenylammonium chloride, tetrahexylammonium chloride, a benzalkonium chloride, a mixture of alkyltrimethylammonium chlorides, or mixtures thereof.

11. The solution of claim 10 wherein the quaternary ammonium (I) is a mixture of dodecyl-, tetradecyl- and hexadecyl-dimethylbenzyl-ammonium chlorides.

12. The solution of claim 1 or 5 wherein A is

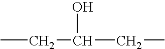

13. The solution of claim 12 wherein the polymeric quaternary ammonium (II) is poly(2-hydroxyethylenedimethyliminio-2-hydroxypropylenedimethyliminiomethylene)dichloride.

14. The solution of claim 1 or 5 wherein said phosphonic or phosphinic acid is represented by formula (III) or (IV),
R₇N(CH₂PO_{z}M₂)₂ (III)
R₈R₉C(PO_{z}M₂)₂ (IV)
wherein z is 2 or 3,
R₇ is selected from the group consisting of hydrogen, an alkyl group of 1 to 12 carbon atoms, an alkylaminoalkyl group wherein each alkyl group has 1 to 12 carbon atoms, an alkoxyalkyl group of 2 to 12 carbon atoms, a cycloalkyl group of 5 to 10 carbon atoms in the ring, a 5- to 10-membered heterocyclic group having one or more nitrogen, oxygen or sulfur atoms in the heterocyclic ring, or —CHR₁₀PO_{z}M₂.
R₈ is selected from the group consisting of hydrogen, an alkyl group of 1 to 12 carbon atoms, an aryl group of 6 to 10 carbon atoms in the aromatic ring, a cycloalkyl group of 5 to 10 carbon atoms in the ring, a 5- to 10-membered heterocyclic group having one or more nitrogen, oxygen or sulfur atoms in the heterocyclic ring, —PO_{z}M₂ or —CHR₁₀PO_{z}M₂,
R₉ and R₁₀ are independently selected from the group consisting of hydrogen, a hydroxy group, an alkyl group of 1 to 12 carbon atoms, or PO_{z}M₂, and
M is hydrogen.

15. The solution of claim 14 wherein the chelating agent comprising an alkali metal salt is an alkali metal salt of aminotris(methylenephosphonic) acid.

16. The solution of claim 1 or 5 wherein it comprises a p-aminophenol as stannous ion stabilizer.

17. The solution of claim 1 or 5, being free of propionic acid.

18. The solution of claim 1 or 5, containing the combination of acetic acid with an acetate as buffering agent.

19. A method of processing an exposed color reversal photographic film comprising the circulation of said exposed film in a ready-to-use reversal solution according to any one of claims 5 to 18, and the color development of said film.
